(19) United States
(12) Patent Application Publication
(10) Pub. No.: US 2015/0286801 A1
(43) Pub. Date: Oct. 8, 2015

(54) Representing Inclusion and Exclusion Criteria for Identifying Clinical Cohorts

(71) Applicant: International Business Machines Corporation, Armonk, NY (US)

(72) Inventor: Tanveer F. Syeda-Mahmood, Santa Clara, CA (US)

(73) Assignee: International Business Machines Corporation, Armonk, NY (US)

(21) Appl. No.: 14/243,095

(22) Filed: Apr. 2, 2014

(51) Int. Cl. G06F 19/00

(52) U.S. Cl. CPC G06F 19/363

(57) ABSTRACT

Embodiments relate to selection systems and methods for identifying patient cohorts. One aspect is a computer-implemented method including receiving one or more cohort criteria for a clinical study. The cohort criteria indicate at least one of inclusion criteria for inclusion in the clinical study and exclusion criteria for exclusion from the clinical study. The cohort criteria are transformed into a constraint tree. The constraint tree is traversed, by a computer processor, to apply the cohort criteria to the plurality of patient records. As a result of the traversing, a patient cohort of one or more patients is identified from among a plurality of patient records.

### BACKGROUND

Various embodiments of this disclosure relate to selecting patients for healthcare studies and, more specifically, to representing inclusion and exclusion criteria so as to make such selection efficiently.

With the rising cost of healthcare, clinical studies have become necessary to rigorously evaluate the impact of various treatments, procedures, and interventions. Often the results of clinical studies arrive at physicians long after such studies have ended (e.g., months later), thereby limiting the value of a clinical study to patients currently being seen by physicians. One result of this is widespread practice variations, where physicians employ their own biases due to familiarity with particular treatments or cost and insurance considerations, as opposed to applying knowledge gained during concluded clinical studies.

Both clinical studies and follow-on formal clinical trials are traditionally time-consuming, costly, and often incomplete. In the United States, spending on clinical research exceeds $35 billion, and clinical grant spending now tops $11 billion. Many of these trials end unsuccessfully, not only because of operational difficulties, but also due to more fundamental issues of selecting the wrong hypotheses or inappropriate patient cohorts. Whether a clinical trial is conducted through a contract research organization (CRO) or by recruiting investigators, access to patient cohorts remains a bottleneck in the clinical trial process. Currently, cohorts are selected either through open participation, by using media for recruitment (e.g., radio ads), or by relying on clinical investigators, who are often selected from academic medical centers and hospitals to identify appropriate cohorts from their respective patient bases.

### SUMMARY

In one embodiment of this disclosure, a computer-implemented method includes receiving one or more cohort criteria for a clinical study. The cohort criteria indicate at least one of inclusion criteria for inclusion in the clinical study and exclusion criteria for exclusion from the clinical study. The cohort criteria are transformed into a constraint tree. The constraint tree is traversed, by a computer processor, to apply the cohort criteria to the plurality of patient records. As a result of the traversing, a patient cohort of one or more patients is identified from among a plurality of patient records.

In another embodiment, a system includes a memory having computer readable instructions and a processor configured to execute the computer readable instructions. The instructions include receiving one or more cohort criteria for a clinical study. The cohort criteria indicate at least one of inclusion criteria for inclusion in the clinical study and exclusion criteria for exclusion from the clinical study. The cohort criteria are transformed into a constraint tree. The constraint tree is traversed, by a computer processor, to apply the cohort criteria to the plurality of patient records. As a result of the traversing, a patient cohort of one or more patients is identified from among a plurality of patient records.

In yet another embodiment, a computer program product includes a computer readable storage medium having computer readable program code embodied thereon. The computer readable program code is executable by a processor to perform a method. The method includes receiving one or more cohort criteria for a clinical study. The cohort criteria indicate at least one of inclusion criteria for inclusion in the clinical study and exclusion criteria for exclusion from the clinical study. Further according to the method, the cohort criteria are transformed into a constraint tree. The constraint tree is traversed to apply the cohort criteria to the plurality of patient records. As a result of the traversing, a patient cohort of one or more patients is identified from among a plurality of patient records.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a selection system, according to some embodiments of this disclosure;

FIG. 2 is an example constraint tree for a first clinical protocol, according to some embodiments of this disclosure;

FIG. 3 is an example constraint tree for a second clinical protocol, according to some embodiments of this disclosure;

FIG. 4 is an interface of the selection system, according to some embodiments of this disclosure;

FIG. 5 is a flow diagram of a method for identifying a patient cohort with the selection system, according to some embodiments of this disclosure; and

FIG. 6 is a block diagram of a computer system for implementing some or all aspects of the selection system, according to some embodiments of this disclosure.

### DETAILED DESCRIPTION

Some embodiments of a selection system according to this disclosure efficiently identify a patient cohort from a set of patient records, based on inclusion criteria, exclusion criteria, or both for the desired cohort.

With the advent of electronic health records, a new channel is now available for recruiting patient cohorts. Typically, patient data is spread out in a hospital between electronic medical record systems (EMRs), radiology PACS systems, laboratory systems, pharmacy order systems, and other systems. This data can be brought together into integrated electronic health records and made searchable, such that various embodiments of the present selection system can be used to identify cohorts. Various embodiments of the selection system may enable clinical studies to be digitally represented and configured for efficient searching through electronic health records based on important variables. These variables are referred to herein as comparative effectiveness research (CER) variables.

Formally conducted clinical studies are required to be registered with ClinicalTrials.gov, a website that provides a format to enter clinical trial information using an XML schema. Among the elements of this schema that are relevant to finding patient cohorts are cohort criteria, such as inclusion criteria and exclusion criteria. The inclusion criteria describe characteristics that are required, or at least desired, of a patient in order for that patient to be selected as part of the cohort. The exclusion criteria describe characteristics that necessarily exclude a patient, or at least disfavor the patient, for inclusion in the cohort even if the inclusion criteria are met.

Inclusion and exclusion criteria are often described in the form of long sentences or phrases. For example, a particular study may have as its inclusion criteria “clinical diagnoses of Hypertrophic Cardiomyopathy” and “ability to perform peak exercise oxygen consumption test,” and may have as its exclusion criteria “left ventricular outflow tract gradient more than 30 mmHG” and “peak oxygen consumption more than 75% of maximum predicted.” In that case, an ideal patient for the cohort would include both of these inclusion criteria and exclude both of these exclusion criteria.

Generally, inclusion and exclusion criteria refer to CER variables, such as demographics, family history, risk factors, symptoms, diagnosis, medications, lab results, diagnostic exams, exam results, treatments and procedures, and outcome, for example. Each of these variables is described in terms of one or more elements and attributes. For example, the diagnosis, which may be represented as a CER variable, may include a disease name as its element, and its associated attributes may be an ICD9 code, severity classification (e.g. stage I or II), and the length of time over which this diagnosis has prevailed. In short, an element of a CER variable may represent a value of the variable, while the attributes may represent qualifiers or further descriptors of the element. Complex combinations of inclusion criteria can be represented by combinations of AND and OR based on the elements and attributes of CER variables, using conventional semantics for these Boolean operators. Since the exclusion criteria may cover the same set of CER variables, exclusion criteria may be modeled similarly, except that a NOT operator may precede the applicable constraints.

Conventional methods of applying inclusion and exclusion criteria are based on a warehouse search model. In other words, according to these methods, patient data is represented in a relational model, and SQL queries representing the inclusion and exclusion criteria are used to determine which patients meet those criteria. Generally, a form interface is provided to a user searching for patients, and the user selects options from drop-down menus to explicitly indicate AND, OR, and NOT constraints related to various predetermined form variables. As a result, a SQL query is constructed at the back-end by predetermined associations between the form variables and potential queries. The resulting SQL queries can become unwieldy for complex inclusion and exclusion criteria, which can have multiple constraints. Further, query performance is often poor, and a system may take days to return answers from a large database.

To effectively search for patients suitable for a cohort using cohort criteria, the selection system may provide a language to formally express the constraints specified in the inclusion and exclusion criteria. The selection system may include both a mechanism for representing the cohort criteria and an algorithm to find patient cohorts using that representation mechanism.

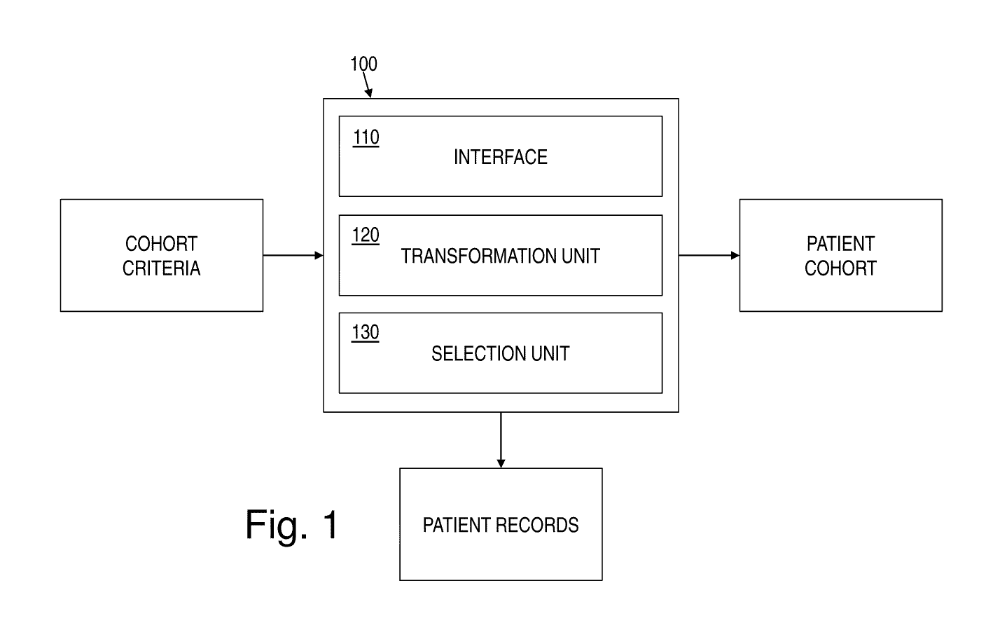

FIG. 1 is a block diagram of the selection system 100, according to some embodiments of this disclosure. As shown, the selection system 100 may receive as input a set of inclusion and exclusion criteria, which the selection system 100 may apply to a set of patient records, each corresponding to a patient. In some embodiments, the selection system 100 may include various units, such as an interface 110, a transformation unit 120, and a selection unit 130. Generally, the interface 110 may enable a user to input cohort criteria; the transformation unit 120 may transform those criteria into a constraint, which will be described further below; and the selection unit 130 may traverse the constraint tree to identify an appropriate patient cohort. The interface 110, the transformation unit 120, and the selection unit 130 may each be made up of hardware, software, or a combination of both. Further, it will be understood that the distinction made between these aspects of the selection system 100 is made for illustrative purposes only; the interface 110, the transformation unit 120, and the selection unit 130 may share hardware, software, or both as needed based on the specific implementation used.

In contrast to conventional systems, according to some embodiments of the selection system 100, an AND-OR-NOT tree may be used to represent cohort criteria. An AND-OR-NOT tree, or a constraint tree, may define a set of cohort constraints (e.g., either or both of inclusion and exclusion criteria), using one or more AND, OR, and NOT constraints. As a result, a patient cohort may be built through recursive, incremental construction, thereby enabling fast searching by use of the constraint tree.

Some embodiments of the selection system 100 may operate on longitudinal patient records, which may be constructed based on various patient records prior to the tree traversal. Algorithms for modeling such longitudinal patient records and their automatic construction are known in the existing art. Some other embodiments of the selection system 100, however, may operate on other patient record representations.

In some embodiments, a clinical protocol for which a patient cohort is sought may be represented as a rooted constraint tree described by the following grammar, which is provided below in Backus Normal Form (BNF) notation:

<Cprot>::= <ANDnode>|<CERinc>|<CERexc>
<CERexc>::=<NOTnode>
<NOTnode>::=<CERinc>
<ANDnode>::=<CERbase>|<CERinc>+
<ORnode>::=<CERbase>|<CERinc>+
<CERinc>::=<CERbase>|<ANDnode>|<ORnode>
<CERbase>::=<cerbasename><element>+
<element>::=<elementname><elementvalue><elementtype><elementunit><attributes>*
<attribute>::=<attributename><attrvalue><attrtype><attrunit>
<cerbasename>::=Demographics|Diagnosis|RiskFactor|FamilyHistory|Drug|Symptom|Me
asurements|Exams|Treatments|Outcome
<elementtype>::=RANGE|BOOLEAN|NUMBER|STRING|ENUM|DATE|...
<elementunit>::=Years|Months|Days|Hours|Any|
<attrtype>::=RANGE|BOOLEAN|NUMBER|STRING|ENUM|DATE|
<attrunit>::=Years|Months|Days|Hours|Any

In the above grammar, elementname and elementvalue may vary based on the cerbasename. Using a cerbasename for family history, for example, each elementname may be a diseasename (i.e., the name of a disease) or a relation (i.e., a family relation). The possible elementvalues for each diseasename may be selected from the entire ICD9 code set of over 15,000 names. The possible elementvalues for relation may be, for example:

“mother”|“father”|“brother”|“sister”|“wife”|“husband”|“spouse”|“maunt”|“paunt”|“Pgm”|“mgm”|“pgf”|“mgf”|“munc”|“punc”|“dau”|“son”|“child”|“gchild”|“other”|“paternal grandfather”|“maternal grandfather”|“paternal grandmother”|“maternal grandmother”|“paternal uncle”|“maternal uncle”|“paternal aunt”|“maternal aunt”|“grand child”|“daughter”|“grandmother”|“grandfather”|“uncle”|“aunt”.

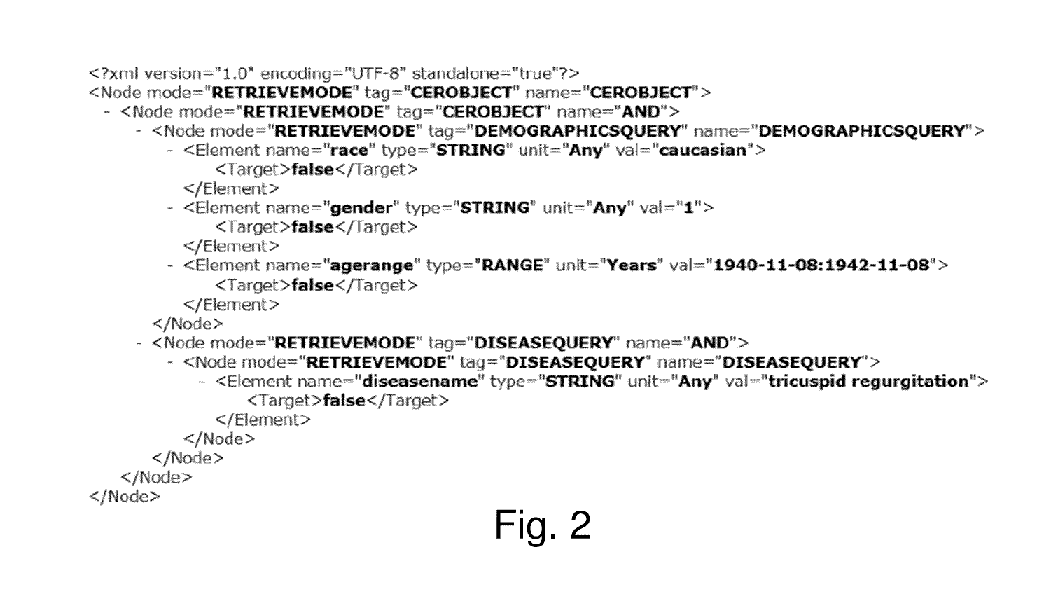

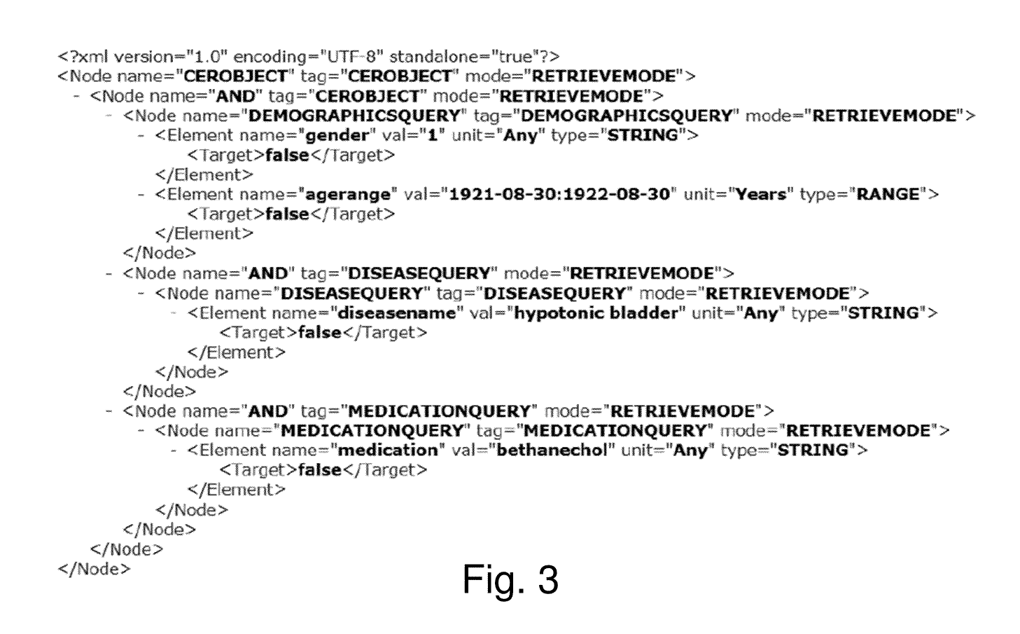

FIGS. 2-3 show example constraint trees using the above grammar. More specifically, FIG. 2 shows a constraint tree for a clinical protocol query search for 70-72 year old Caucasian males suffering from tricuspid regurgitation, while FIG. 3 shows a constraint tree for a clinical protocol query looking for 90-91 years male with a hypotonic bladder who are taking bethanechol.

Generally, given a constraint tree for a clinical protocol, the selection system 100 may find patient records corresponding to patients that match the associated constraints through recursive traversal of the constraint tree. More specifically, a potential patient cohort may be identified at each node of the constraint tree, and the potential cohorts may thereby be accumulated based on the AND, OR, and NOT semantics. For example, in one embodiment, given a subtree headed by an AND node (i.e., with an AND node at the root of the subtree), only the patient cohorts that satisfy all children criteria may be retained for the next level of propagation. On the other hand, in that same embodiment, given a subtree headed by an OR node, all patient cohorts from the children may accumulated and propagated to the next upper levels. Finally, given a subtree headed by the NOT node in that embodiment, all patient cohorts under the NOT tree are removed from the other cohorts returned from the other children. By the time the tree has been fully traversed, one patient cohort may be retained corresponding to the root node, where that cohort includes all patients from the cohorts that were propagated all the way upward through not having been eliminated. That final patient cohort may then be recommended to the system user.

In alternative embodiments, all patients may be retained in the accumulated patient cohort as the tree is being traversed. Points may be awarded to each patient record throughout the traversal, resulting in each patient record having a score of accumulated points. For example, each patient record that satisfies a node's current query related to a CER variable may receive a point, which may positively affect that patient record's score. In that case, since exclusion criteria may be represented using a NOT operator, lack of the exclusion characteristics may also result in a point, which may positively affect the score. Thus, a patient record may be rewarded for meeting inclusion criteria and not rewarded for meeting exclusion criteria. After the constraint tree has been fully traversed, each patient record may then be associated with a score, corresponding the points awarded during the tree traversal. The selection system 100 may then select the patient records with the highest scores to represent the final patient cohort. After a final patient cohort is identified, the selection system 100 may then recommend that patient cohort to the system user.

The algorithm for finding patient cohorts using a constraint tree may proceed by recursively traversing the constraint tree in a depth-first manner and computing the cohort set as described below. Let S(nᵢ) be the patient cohort selected at node then the patient cohort at each node may be assembled for each type of node as:

$$S ( Cprot ) = \{ \begin{matrix}S ( CERinc ) , if only inclusion criteria exist \\ S ( CE Re xc ) , if only exclusion criteria exist \\ S ( ANDnode ) , if both criteria exist \end{matrix} \\ S ( CERinc ) = \{ \begin{matrix}S ( CERbase ) , if CERinc has only one leaf \\ S ( ANDnode , if CERinc has an ANDnode as a child \\ S ( ORnode ) , if CERinc has an ORnode as a child \end{matrix} \\ S ( CE Re xc ) = S ( NOTnode ) \\ S ( NOTnode ) = N - S ( CERinc ) \\ S ( ANDnode ) = \{ \begin{matrix}S ( CERbase ) , if the node has only one child leaf \\ {⋂}_{i} S ( {CERinc}_{i} ) , over all children leaves i\end{matrix} \\ S ( ORnode ) = \{ \begin{matrix}S ( CERbase ) , if the node has only one child leaf \\ {⋃}_{i} S ( {CERinc}_{i} ) , over all children leaves i\end{matrix} \\ S ( CERbase ) = {⋂}_{i} S ( {element}_{i} ) , over all children leaves i \\ S ( element ) = S ( elementname ) {⋂}_{i} S ( {attrname}_{i} ) , over all children leaves i$$

In some embodiments, the depth-first search performed by the selection system 100 may be represented by the pseudocode below:

CohortSearch(CERNode n) {

CohortSofar qd=null;
if (n is ANDnode) {

for all children c of n do

qd= ANDQueryResult(qd,CohortSearch(c));

}
else if (n is ORnode) {

for all children c of n do

qd= ORQueryResult(qd,CohortSearch(c));

}
else if (n is NOTnode) {

for all children c of n do

qd= NOTQueryResult(qd,CohortSearch(c));

}
else return BaseQueryResult(n);
return qd;

}

In the above, the BaseQueryResult(n) may perform the leaf-level cohort look-up and may correspond to the operation S(element)=S(elementname)∩ᵢS(attrnameᵢ).

In other words, each leaf of the constraint tree may contain a patient characteristic. While traversing the tree, if the current node is a leaf node (not AND, OR, or NOT node), the selection system 100 may run a base query. Execution of a base query may take various forms. For example, and not by way of limitation, a base query may be executed through a database query or by use of a document index. The base query may determine which patient records have the characteristic corresponding to the current node. That characteristic may be, for example, the existence of a certain element value or attribute related to a CER variable. If the current node is an AND node, then the selection system 100 may AND the results of all child nodes of the current node. Thus, all patient records in the potential cohorts of each and every child nodes may be retained (or the associated scores may be adjusted, depending on the embodiment) moving forward. If current node is an OR node, then the selection system 100 may OR the results of the child nodes. Thus, each patient record in any of the potential cohorts of the child nodes may be retained (or the associated scores may be adjusted, depending on the embodiment) moving forward. If the current node is a NOT node, then the selection system 100 may NOT the results of the child nodes. In some embodiments, a NOT node may have only a single child node. Thus, each patient record not represented in the potential cohort of that child node may be retained (or the associated scores may be adjusted, depending on the embodiment) moving forward. After full traversal of the tree, a final patient cohort may be identified, for example, based on total scores or based on which patient records were propagated all the way up the tree.

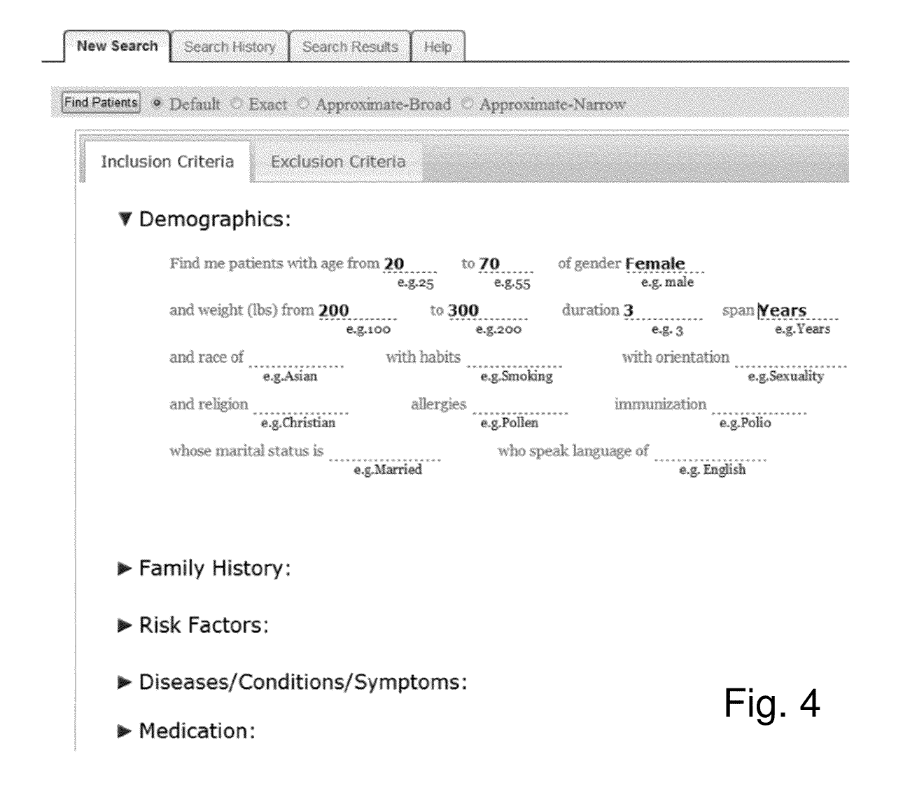

FIG. 4 is an example of an interface for the selection system 100, according to some embodiments. This interface may be, for example, a web interface or a local application interface. The above algorithm may compute a patient cohort in time linear in the number of nodes. To apply the algorithm, a user may select a list of elements and attributes corresponding to the CER variables of interest in a clinical study and enter them as inclusion or exclusion criteria. For each blank space to be filled in by a user, the interface may provide various mechanisms for entering data for the resulting SQL searches. For example, and not by way of limitation, each blank may be associated with a drop-down box from which the user can select a value to occupy that blank. Alternatively, for example, each blank may be a text box into which the user can enter a value. The selection system 100 may transform the entered data into a constraint tree, such as those shown in FIGS. 2-3. The constraint tree may then be traversed using the above algorithm to identify a desirable patient cohort.

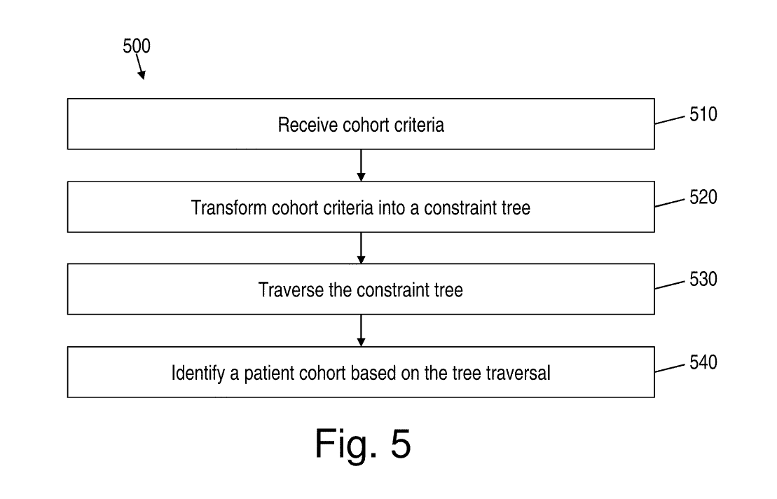

FIG. 5 is a flow diagram of a method 500 for identifying a patient cohort from a set of patient records, according to some embodiments. As shown, at block 510, a set of cohort criteria (e.g., inclusion and exclusion criteria) may be received. At block 520, these cohort criteria may be transformed into a constraint tree. At block 530, the constraint tree may be traversed. A final patient cohort may then be identified and recommended, at block 540, based on the tree traversal. It will be understood that other methods may also be used for identifying patient cohorts according to this disclosure.

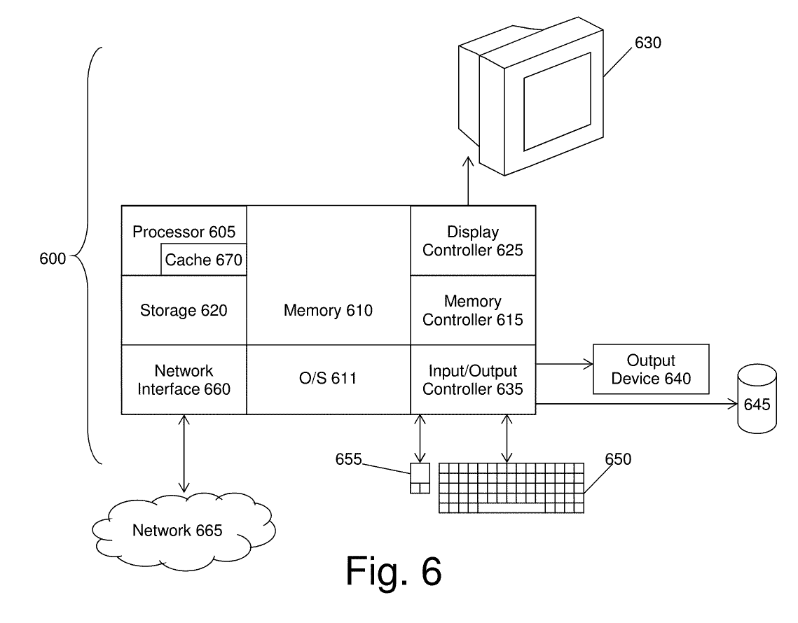

Some embodiments of the selection system 100 may be implemented, in whole or in part, by a computer system. FIG. 6 illustrates a block diagram of a computer system 600 for use in implementing a selection system 100 or method 500 according to some embodiments. The selection systems 100 and methods 500 described herein may be implemented in hardware, software (e.g., firmware), or a combination thereof. In an exemplary embodiment, the methods described may be implemented, at least in part, in hardware and may be part of the microprocessor of a special or general-purpose computer system 600, such as a personal computer, workstation, minicomputer, or mainframe computer.

In an exemplary embodiment, as shown in FIG. 6, the computer system 600 includes a processor 605, memory 610 coupled to a memory controller 615, and one or more input devices 645 and/or output devices 640, such as peripherals, that are communicatively coupled via a local I/O controller 635. These devices 640 and 645 may include, for example, a printer, a scanner, a microphone, and the like. A conventional keyboard 650 and mouse 655 may be coupled to the I/O controller 635. The I/O controller 635 may be, for example, one or more buses or other wired or wireless connections, as are known in the art. The I/O controller 635 may have additional elements, which are omitted for simplicity, such as controllers, buffers (caches), drivers, repeaters, and receivers, to enable communications.

The I/O devices 640, 645 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 605 is a hardware device for executing hardware instructions or software, particularly those stored in memory 610. The processor 605 may be any custom made or commercially available processor, a central processing unit (CPU), an auxiliary processor among several processors associated with the computer system 600, a semiconductor based microprocessor (in the form of a microchip or chip set), a macroprocessor, or other device for executing instructions. The processor 605 includes a cache 670, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 670 may be organized as a hierarchy of more cache levels (L1, L2, etc.).

The memory 610 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 may incorporate electronic, magnetic, optical, or other types of storage media. Note that the memory 610 may have a distributed architecture, where various components are situated remote from one another but may be accessed by the processor 605.

The instructions in memory 610 may include one or more separate programs, each of which comprises an ordered listing of executable instructions for implementing logical functions. In the example of FIG. 6, the instructions in the memory 610 include a suitable operating system (OS) 611. The operating system 611 essentially may control the execution of other computer programs and provides scheduling, input-output control, file and data management, memory management, and communication control and related services.

Additional data, including, for example, instructions for the processor 605 or other retrievable information, may be stored in storage 620, which may be a storage device such as a hard disk drive or solid state drive. The stored instructions in memory 610 or in storage 620 may include those enabling the processor to execute one or more aspects of the selection systems 100 and methods 500 of this disclosure.

The computer system 600 may further include a display controller 625 coupled to a display 630. In an exemplary embodiment, the computer system 600 may further include a network interface 660 for coupling to a network 665. The network 665 may be an IP-based network for communication between the computer system 600 and any external server, client and the like via a broadband connection. The network 665 transmits and receives data between the computer system 600 and external systems. In an exemplary embodiment, the network 665 may be a managed IP network administered by a service provider. The network 665 may be implemented in a wireless fashion, e.g., using wireless protocols and technologies, such as WiFi, WiMax, etc. The network 665 may also be a packet-switched network such as a local area network, wide area network, metropolitan area network, the Internet, or other similar type of network environment. The network 665 may be a fixed wireless network, a wireless local area network (LAN), a wireless wide area network (WAN) a personal area network (PAN), a virtual private network (VPN), intranet or other suitable network system and may include equipment for receiving and transmitting signals.

Selection systems 100 and methods 500 according to this disclosure may be embodied, in whole or in part, in computer program products or in computer systems 600, such as that illustrated in FIG. 6.

Technical effects and benefits include the ability to efficiently identify patients for clinical trials, without the use of unwieldy and slow queries. The selection system 100 may create new business opportunities for large hospitals, who, after obtaining patient consent, can participate in the selection process by offering their patients for clinical trials in a de-identified manner. Further, it will be understood that embodiments of the selection system 100 need not be limited to identifying patient cohorts, and may be used to identify subgroups of individuals or entities for various purposes.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving one or more cohort criteria for a clinical study, wherein the cohort criteria indicate at least one of inclusion criteria for inclusion in the clinical study and exclusion criteria for exclusion from the clinical study;
transforming the cohort criteria into a constraint tree;
traversing, by a computer processor, the constraint tree to apply the cohort criteria to the plurality of patient records; and
identifying, as a result of the traversing, a patient cohort of one or more patients from among a plurality of patient records.

2. The method of claim 1, wherein the constraint tree comprises a plurality of interior nodes and a plurality of leaf nodes, and wherein each of the interior nodes represents a Boolean operation related to the cohort criteria.

3. The method of claim 2, wherein identifying the patient cohort of one or more patients from among the plurality of patient records further comprises executing a query at each interior node of the constraint tree during the tree traversal.

4. The method of claim 2, wherein identifying the patient cohort of one or more patients from among the plurality of patient records further comprises, at each interior node of the constraint tree, propagating a subset of the plurality of patient records upward in the tree traversal.

5. The method of claim 2, wherein each leaf node represents a base query for determining which of the plurality of patient records comprise a characteristic related to the cohort criteria.

6. The method of claim 1, wherein the patient cohort comprises patients corresponding to a subset of the plurality of patient records that excludes patient records having at least one of the exclusion criteria and includes patient records having the inclusion criteria.

7. The method of claim 1, wherein identifying the patient cohort of one or more patients from among the plurality of patient records further comprises modifying a score of each patient record when an aspect of an inclusion criterion is met by that patient record.

8. A system comprising:
a memory having computer readable instructions; and
a processor configured to execute the computer readable instructions, the instructions comprising:
receiving one or more cohort criteria for a clinical study, wherein the cohort criteria indicate at least one of inclusion criteria for inclusion in the clinical study and exclusion criteria for exclusion from the clinical study;
transforming the cohort criteria into a constraint tree;
traversing the constraint tree to apply the cohort criteria to the plurality of patient records; and
identifying, as a result of the traversing, a patient cohort of one or more patients from among a plurality of patient records.

9. The system of claim 8, wherein the constraint tree comprises a plurality of interior nodes and a plurality of leaf nodes, and wherein each of the interior nodes represents a Boolean operation related to the cohort criteria.

10. The system of claim 9, wherein identifying the patient cohort of one or more patients from among the plurality of patient records further comprises, at each interior node of the constraint tree, executing a query and propagating a subset of the plurality of patient records upward in the tree traversal.

11. The system of claim 9, wherein each leaf node represents a base query for determining which of the plurality of patient records comprise a characteristic related to the cohort criteria.

12. The system of claim 8, wherein the patient cohort comprises patients corresponding to a subset of the plurality of patient records that excludes patient records having at least one of the exclusion criteria and includes patient records having the inclusion criteria.

13. The system of claim 8, wherein identifying the patient cohort of one or more patients from among the plurality of patient records further comprises modifying a score of each patient record when an aspect of an inclusion criterion is met by that patient record.

14. A computer program product comprising a computer readable storage medium having program instructions embodied therewith, the program instructions readable by a processing circuit to cause the processing circuit to perform a method comprising:
receiving one or more cohort criteria for a clinical study, wherein the cohort criteria indicate at least one of inclusion criteria for inclusion in the clinical study and exclusion criteria for exclusion from the clinical study;
transforming the cohort criteria into a constraint tree;
traversing the constraint tree to apply the cohort criteria to the plurality of patient records; and
identifying, as a result of the traversing, a patient cohort of one or more patients from among a plurality of patient records.

15. The computer program product of claim 14, wherein the constraint tree comprises a plurality of interior nodes and a plurality of leaf nodes, and wherein each of the interior nodes represents a Boolean operation related to the cohort criteria.

16. The computer program product of claim 15, wherein identifying the patient cohort of one or more patients from among the plurality of patient records further comprises executing a query at each interior node of the constraint tree during the tree traversal.

17. The computer program product of claim 15, wherein identifying the patient cohort of one or more patients from among the plurality of patient records further comprises, at each interior node of the constraint tree, propagating a subset of the plurality of patient records upward in the tree traversal.

18. The computer program product of claim 15, wherein each leaf node represents a base query for determining which of the plurality of patient records comprise a characteristic related to the cohort criteria.

19. The computer program product of claim 14, wherein the patient cohort comprises patients corresponding to a subset of the plurality of patient records that excludes patient records having at least one of the exclusion criteria and includes patient records having the inclusion criteria.

20. The computer program product of claim 14, wherein identifying the patient cohort of one or more patients from among the plurality of patient records further comprises modifying a score of each patient record when an aspect of an inclusion criterion is met by that patient record.
